(19) United States
(12) Patent Application Publication
(10) Pub. No.: US 2024/0424663 A1
(43) Pub. Date: Dec. 26, 2024

(54) ROBOT-MEDIATED PHYSICAL HUMAN-HUMAN INTERACTION

(71) Applicant: Honda Motor Co., Ltd., Tokyo (JP)

(72) Inventors: Emek Baris KÜÇÜKTABAK, Chicago, IL (US); Rana SOLTANI ZARRIN, Los Gatos, CA (US)

(21) Appl. No.: 18/341,318

(22) Filed: Jun. 26, 2023

(51) Int. Cl. B25J 3/00; B25J 13/08

(52) U.S. Cl. CPC B25J 3/00; B25J 13/082; B25J 13/089

(57) ABSTRACT

Robot-mediated physical human-human interaction may be implemented by receiving an interaction wrench signal indicative of a wrench force associated with a first robot portion, receiving an end-effector pose signal indicative of a pose associated with a second robot portion, generating a constraint signal indicative of a constraint associated with the first robot portion based on the end-effector pose signal associated with the second robot portion, and implementing the constraint associated with the first robot portion as feedback on the second robot portion. The robot-mediated physical human-human interaction may enable creation of robot-mediated physical interaction between multiple humans in a general setting while considering constraints with different priorities for each robot portion.

### BACKGROUND

Humans may physically interact with each other to accomplish tasks that may be difficult to do individually or to help each other. Some examples of such interaction may include carrying a large piece of furniture together, helping a person to get up after a fall, a medical doctor examining a patient, a physical therapist guiding a patient or a sports coach teaching a new movement.

### BRIEF DESCRIPTION

According to one aspect, a system for robot-mediated physical human-human interaction may include a processor and a memory. The memory may store one or more instructions. The processor may execute one or more of the instructions stored on the memory to perform one or more acts, actions, and/or steps, such as receiving an interaction wrench signal indicative of a wrench force associated with a first robot portion, receiving an end-effector pose signal indicative of a pose associated with a second robot portion, generating a constraint signal indicative of a constraint associated with the first robot portion based on the end-effector pose signal associated with the second robot portion, and implementing the constraint associated with the first robot portion as feedback on the second robot portion.

The wrench force of the interaction wrench signal may be indicative of an interaction between a first human and the first robot portion. The end-effector pose signal may be provided by a second human interacting with the second robot portion. The end-effector pose signal may be indicative of a desired pose for the first robot portion. The constraint signal may be indicative of a joint torque limitation, a joint velocity limitation, a joint acceleration limitation, or a joint position limitation for the second robot portion. The constraint signal may be indicative of a space limitation for the second robot portion. The constraint signal may be indicative of an interaction force limitation for the second robot portion.

The processor may receive an interaction wrench signal indicative of a wrench force associated with the second robot portion. The processor may receive an end-effector pose signal indicative of a pose associated with the first robot portion. The processor may generate a constraint signal indicative of a constraint associated with the second robot portion based on the end-effector pose signal associated with the first robot portion. The processor may implement the constraint associated with the second robot portion as feedback on the first robot portion.

The processor may generate the constraint signal to be indicative of a second constraint associated with the first robot portion based on the end-effector pose signal associated with the second robot portion. The processor may prioritize the constraint and the second constraint based on whether the first robot portion may be acting as an operator or a partner. The processor may implement the constraint and the second constraint.

According to one aspect, a computer-implemented method for robot-mediated physical human-human interaction may include receiving an interaction wrench signal indicative of a wrench force associated with a first robot portion, receiving an end-effector pose signal indicative of a pose associated with a second robot portion, generating a constraint signal indicative of a constraint associated with the first robot portion based on the end-effector pose signal associated with the second robot portion, and implementing the constraint associated with the first robot portion as feedback on the second robot portion.

The wrench force of the interaction wrench signal may be indicative of an interaction between a first human and the first robot portion. The end-effector pose signal may be provided by a second human interacting with the second robot portion. The end-effector pose signal may be indicative of a desired pose for the first robot portion. The constraint signal may be indicative of a joint torque limitation, a joint velocity limitation, a joint acceleration limitation, or a joint position limitation for the second robot portion. The constraint signal may be indicative of a space limitation for the second robot portion. The constraint signal may be indicative of an interaction force limitation for the second robot portion.

The computer-implemented method for robot-mediated physical human-human interaction may include receiving an interaction wrench signal indicative of a wrench force associated with the second robot portion, receiving an end-effector pose signal indicative of a pose associated with the first robot portion, generating a constraint signal indicative of a constraint associated with the second robot portion based on the end-effector pose signal associated with the first robot portion, and implementing the constraint associated with the second robot portion as feedback on the first robot portion.

According to one aspect, a system for robot-mediated physical human-human interaction may include a processor and a memory. The memory may store one or more instructions. The processor may execute one or more of the instructions stored on the memory to perform one or more acts, actions, and/or steps, such as receiving an interaction wrench signal indicative of a wrench force associated with a first robot portion, generating and transmitting an end-effector pose signal indicative of a pose associated with a second robot portion, receiving a constraint signal indicative of a constraint associated with the first robot portion based on the end-effector pose signal associated with the second robot portion, and implementing the constraint associated with the first robot portion as feedback on the second robot portion.

### BRIEF DESCRIPTION OF THE DRAWINGS

FIG. 1 is an exemplary component diagram of a system for robot-mediated physical human-human interaction, according to one aspect.

FIG. 2 is an exemplary component diagram of a system for robot-mediated physical human-human interaction, according to one aspect.

FIG. 3 is an exemplary illustration of a system for robot-mediated physical human-human interaction, according to one aspect.

FIG. 4 is an exemplary flow diagram of a computer-implemented method for robot-mediated physical human-human interaction, according to one aspect.

FIG. 5 is an illustration of an example computer-readable medium or computer-readable device including processor-executable instructions configured to embody one or more of the provisions set forth herein, according to one aspect.

FIG. 6 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

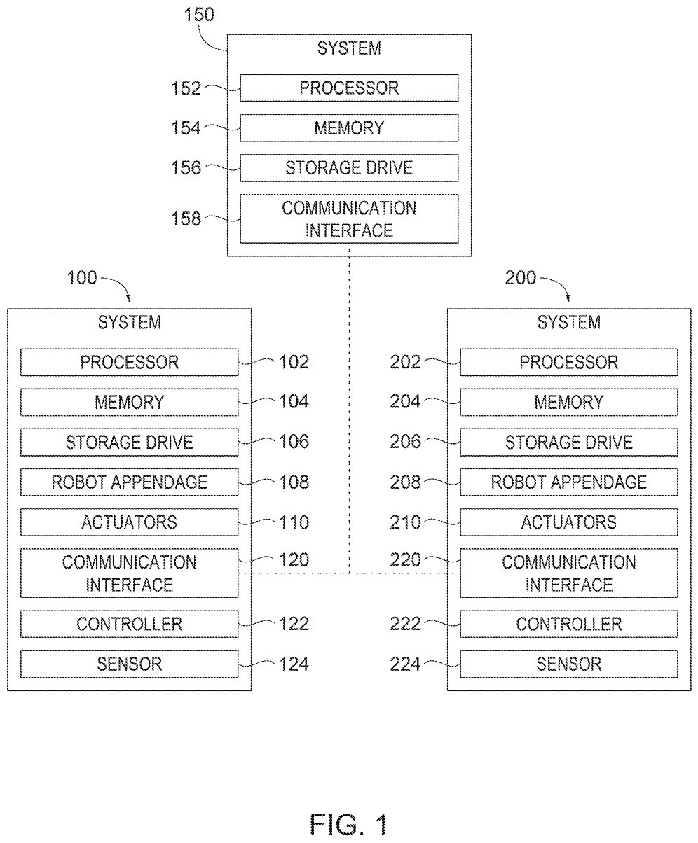

FIG. 1 is an exemplary component diagram of a system for robot-mediated physical human-human interaction, according to one aspect. The system for robot-mediated physical human-human interaction may include one or more system portions, such as a first robot portion 100, a second robot portion 200, and a control portion 150. The system for robot-mediated physical human-human interaction may enable robot-mediated physical human-human interaction by allowing a first user to interact with the first robot portion 100 and a second user to interact with the second robot portion 200. During the interaction, the system for robot-mediated physical human-human interaction may treat one of the robot portions as an operator and the other robot portion as a partner. For example, the first robot portion 100 may act as the partner and the second robot portion 200 may act as the operator. In this example, the interaction created by the second user and the second robot portion 200 may be replicated, with one or more constraints, on the first robot portion 100 via the control portion 150, which may perform one or more calculations for the constraints, as will be described in greater detail herein.

While aspects described herein provide that the control portion 150 may perform one or more calculations for the first robot portion 100 and/or the second robot portion 200, it will be appreciated that either the first robot portion 100 and/or the second robot portion 200 may perform any of the calculations, analysis, and/or computations described herein.

Robot-mediated physical interaction between humans may allow remote physical communication to accomplish tasks with one another or to provide physical assistance. The robot-mediated physical human-human interaction may enable creation of robot-mediated physical interaction between multiple humans in a general setting while considering constraints with different priorities.

Using robots to mediate physical human-human interaction may allow customizing the physical interface between individuals and remote physical human-human interaction. Each individual may physically interact with their own robot, and robots may be programmed to render a desired interaction between two humans. Physically assisting an elderly in the distance or physical telerehabilitation may be possible usages of such an infrastructure. For many possible scenarios, one human may have a more dominant, leader-like role, while the other user may have a follower-like role. As described herein, a more dominant user may be an operator and a less dominant user may be a follower or partner.

Using robots to mediate physical interaction may bring additional factors to consider. Human-robot interaction may be grouped into four main parts: control, motion planning, prediction, and psychological considerations. It may be assumed that the operator handles the motion planning, prediction, and psychological considerations, and focus on the features that may be enforced with lower-level control methods. Control-based may be divided into two main groups: pre-contact and post-contact (e.g., hands-off, and hands-on). Limiting the end-effector velocity or not allowing entry to a restricted region may be some examples of pre-contact features. Also, when contact is desired, limiting the forces and transferred power between the human and the robot is desired to avoid discomfort.

Even though these standards may be for single human-robot interaction, the standards may be extended into a robot-mediated human-human interaction framework to ensure protection for both the operator and partner. Moreover, depending on the scenario, these constraints might have different priorities, and it might not be possible to simultaneously satisfy all of them. For example, if the robot may be near sharp objects, keeping the robot away from a specific region should have more priority than keeping the interaction forces below a threshold. Conversely, if the robot may be in contact with a sensitive human part (e.g., face, neck), keeping the interaction forces below a threshold might be more important than other constraints. Moreover, it may be desired for the operator to feel any constraints that may be active on the partner's side to have an intuitive interaction and to avoid any confusion.

One of the benefits provided herein is that the operator's robot does not need to receive the joint states of the partner's robot or its kinematic parameters or dynamic parameters. Additionally, another benefit or advantage may be the ability to add multiple and/or different constraints as desired with different priorities, while creating a bilateral physical interaction between two humans. In this way, the system may haptically feed the partner's constraint to the operator regardless of how many constraints may be active and without the knowledge of the kinematic/dynamic information of the partner's robot. Moreover, the framework allows one person to feel the constraints of the other person's robot without that robot's kinematic/dynamic details. Specifically, a hierarchical optimization scheme may be implemented with higher priority tasks (e.g., interaction force limit) and lower priority bilateral interaction and constraint feeling tasks.

The first robot portion 100 may include a processor 102, a memory 104, a storage drive 106, a robot appendage 108, such as a robotic arm including a robotic hand, joints, and robotic digits or fingers, etc., one or more actuators 110 moving the robot appendage, a communication interface 120, a controller 122, and one or more sensors 124.

Similarly, the second robot portion 200 may include a processor 202, a memory 204, a storage drive 206, a robot appendage 208, such as a robotic arm including a robotic hand, joints, and robotic digits or fingers, etc., one or more actuators 210 moving the robot appendage, a communication interface 220, a controller 222, and one or more sensors 224.

The control portion 150 may include a processor 142, a memory 154, a storage drive 156, and a communication interface 158. According to one aspect, the first robot portion 100, the second robot portion 200, and the control portion 150 may be remote from one another, as illustrated in FIG. 1. According to another aspect, the first robot portion 100, the second robot portion 200, and the control portion 150 may be local, as illustrated in FIG. 3.

The first robot portion 100, the second robot portion 200, and the control portion 150 may be in computer communication and/or communicatively coupled with one another via the communication interfaces 120, 220, 158.

According to one aspect, one or more degree of freedom (DoF) robots may be used as the operator's robot portion (e.g., second robot portion 200) and the partner's robot portion (e.g., first robot portion 100). The robot portions 100, 200 may be attached to a base in a symmetrical manner. According to another aspect, the robot portions 100, 200 may or may not be attached to the same base and may or may not necessarily be in the same physical location. In other words, the robot portions 100, 200 may be remote from one another. Both robot portions may be equipped with 6 DoF force/torque (F/T) sensors. A gripper may be attached to the operator's robot portion. The partner's robot portion may be equipped with a robotic hand to be able to have a firm grasp with human limbs or with objects.

The equation of motion of the operator's (i=P) and partner's (i=0) may be written as:

$${M}_{i} ( q ) {\ddot{q}}_{ι} + {b}_{i} ( q , \dot{q} ) + {g}_{i} ( q ) = {τ}_{motor}^{i} - {τ}_{fric}^{i} - {J}_{i}^{T} {F}_{int}^{i} , i ∈ \{ O , P \} \qquad ( 1 )$$

where q may be the joint positions, M may be the mass matrix, b may be the Coriolis vector, g may be the gravitation vector. The variable τₘₒₜₒᵣ may be the motor torque, τ_{fric} may be the frictional torques at the joints. A friction model and estimated parameters may be implemented. Fᵢₙₜ may be the interaction forces measured at the end-effector via the F/T sensor. The force and the resulting moment due to weights of the gripper and robot hand may be subtracted from the sensor measurements to calculate Fᵢₙₜ. The Jacobian of the end-effector represented in the corresponding world coordinate frame may be represented by J.

Both of the robot portions, F/T sensors, and hand may be connected to the control portion 150, according to one aspect. The states of the robot portions may be received and motor torque commands may be set to a predetermined frequency. Independent nodes may be run for each robot portion in addition to a communication node. The robot portions may have access to their own kinematic/dynamic parameter and not the other robot portion's. Task-space parameters may be exchanged between the communication node to allow generalization of the method to different robot portions with different properties.

A leader-follower scheme may be implemented to create bilateral physical interaction between the two human users. The operator's six-dimensional task space end-effector pose may be sent as the desired pose to the partner's robot portion. Similarly, the six-dimensional wrench felt on the partner's end-effector may be sent to the operator's robot portion as the desired interaction wrench. This enables the operator to guide the partner while feeling the forces and torques applied by the operator. According to one aspect, the processor 152 may receive an interaction wrench signal indicative of a wrench force associated with the first robot portion 100 and receive an end-effector pose signal indicative of a pose associated with the second robot portion 200. The wrench force of the interaction wrench signal may be indicative of an interaction between a first human and the first robot portion 100. The end-effector pose signal may be provided by a second human interacting with the second robot portion 200. The end-effector pose signal may be indicative of a desired pose for the first robot portion 100.

While creating the bilateral physical interaction, it may be desired to ensure the sent commands are physically feasible and not violating any system capabilities of any system portions or robot portions. Moreover, it may be desired that the robot portion does not enter any restricted regions or that the forces applied to the humans do not exceed certain thresholds. Depending on the application, these constraints may have different priorities.

For example, if the partner is elderly, constraints on the interaction forces might have a higher priority than task space constraints. Conversely, if the robot portion operates near sensitive areas, like face or chest, task space constraints might be more desired to enforce than the interaction force constraints. In this regard, the processor 152 may generate a constraint signal indicative of a constraint associated with the first robot portion 100 based on the end-effector pose signal associated with the second robot portion 200. The processor 152 may generate the constraint signal to be indicative of a second constraint associated with the first robot portion 100 based on the end-effector pose signal associated with the second robot portion 200. The processor 152 may prioritize the constraint and the second constraint based on whether the first robot portion 100 is acting as an operator or a partner, or based on input from a high-level processor or a human operator, for example. The processor 152 may implement the constraint and the second constraint.

The first constraint or the second constraint of the constraint signal may be indicative of a joint torque limitation, a joint velocity limitation, a joint acceleration limitation, a joint position limitation, a space limitation, an interaction force limitation for either one of the first robot portion 100 or the second robot portion 200. In this way, the first robot portion 100 may be associated with a first set of one or more constraints and the second robot portion 200 may be associated with a second set of one or more constraints. Each one of these sets of constraints may be prioritized individually, differently, or in unique manners. For example, pose tracking or force tracking for one of the robot portions 100, 200 may be done or performed to the extent possible without violating higher priority constraints.

The following hierarchical optimization scheme may be implemented to create robot-mediated physical human-human interaction while having constraints with different priorities.

### Hierarchical Constraints

A task/constraint with priority p may be written as equality and/or inequality constraints:

$${T}_{p} : \{ \begin{matrix}{A}_{p} x = {b}_{p} \\ {D}_{p} x \leq {f}_{p}\end{matrix} \qquad ( 2 )$$

where Aₚ ∈ [symbol] ^{m}^{ₚ}^{x}^{ₙ}, bₚ ∈ [symbol] ^{m}^{ₚ}, Dₚ ∈ [symbol] ^{c}^{ₚ}^{x}^{ₙ}, fₚ ∈ [symbol] ^{c}^{ₚ}. Scalers n, mₚ, Cₚ may be the sizes of optimization vector x, an equality constraint, and an inequality constraint, respectively. Optimization vector x∈ [symbol] ⁿ may be chosen to be the stacked vector of joint accelerations and motor torques, [\ddot{q}]^{T}, [T]^{T}. Tasks may be solved starting from the most prior (p=1) to the least prior (p=nₚ) without compromising from the optimized solution of the higher prior tasks. This may be formulated for task p as:

$$[ \begin{matrix}{x}_{p}^{*} \\ {v}_{p}^{*}\end{matrix} ] = {arg min}_{x , {v}_{p}} ( ‖ {A}_{p} x - {b}_{p} ‖ + ‖ {v}_{p} ‖ ) \qquad ( 3 )$$

$$s . t .$$

$${D}_{p} x - {f}_{p} \leq {v}_{p}$$

$${v}_{p} \geq {0}_{{c}_{p}}$$

$${D}_{1} x - {f}_{1} \leq {v}_{1}^{*}$$

$$⋮$$

$${D}_{p - 1} x - {f}_{p - 1} \leq {v}_{p - 1}^{*}$$

$${A}_{1} x - {b}_{1} = {A}_{1} {x}_{1}^{*} - {b}_{1}$$

$$⋮$$

$${A}_{p - 1} x - {b}_{p - 1} = {A}_{p - 1} {x}_{p - 1}^{*} - {b}_{p - 1}$$

where vₚ ∈ [symbol] ^{m}^{ₚ} may be the slack variable of the inequality constraints, and [x*ₚ^{T}, v*ₚ^{T}]^{T} may be the optimized solution of task p. This formulation may be converted to a standard form of quadratic programming as:

$${ξ}^{*} = [ \begin{matrix}{x}_{p}^{*} \\ {ν}_{p}^{*}\end{matrix} ] = {arg min}_{ξ = {[ {x}^{T} , {v}_{p}^{T} ]}^{T}} ( \frac{1}{2} {ξ}^{T} {H}_{p} ξ + {c}_{p}^{T} ξ ) \qquad ( 4 )$$

$$s . t .$$

$${l}_{p} \leq {K}_{p} ξ \leq {u}_{p}$$

$$where$$

$${H}_{p} = [ \begin{matrix}{A}_{p}^{T} {A}_{p} & {0}_{n \times {c}_{p}} \\ {0}_{{c}_{p} \times n} & {𝕀}_{{c}_{p} \times {c}_{p}}\end{matrix} ] , {c}_{p} = [ \begin{matrix}- {A}_{p}^{T} {b}_{p} \\ {0}_{{c}_{p}}\end{matrix} ]$$

$${K}_{p} = [ \begin{matrix}{D}_{p} & - {𝕀}_{{c}_{p} \times {c}_{p}} \\ {0}_{{c}_{p} \times n} & {𝕀}_{{c}_{p} \times {c}_{p}} \\ {D}_{1} & {0}_{{c}_{1} \times {c}_{p}} \\ ⋮ & ⋮ \\ {D}_{p - 1} & {0}_{{c}_{p - 1} \times {c}_{p}} \\ {A}_{1} & {0}_{{m}_{1} \times {c}_{p}} \\ ⋮ & ⋮ \\ {A}_{p - 1} & {0}_{{m}_{p - 1} \times {c}_{p}}\end{matrix} ]$$

$${l}_{p} = [ \begin{matrix}- {∞}_{{c}_{p}} \\ {0}_{{c}_{p}} \\ - {∞}_{{c}_{1}} \\ ⋮ \\ - {∞}_{{c}_{p - 1}} \\ {A}_{1} {x}_{1}^{*} \\ ⋮ \\ {A}_{p - 1} {x}_{p - 1}^{*}\end{matrix} ] , {u}_{p} = [ \begin{matrix}{f}_{p} \\ {∞}_{{c}_{p}} \\ {v}_{1}^{*} + {f}_{1} \\ ⋮ \\ {v}_{p - 1}^{*} + {f}_{p - 1} \\ {A}_{1} {x}_{1} * \\ ⋮ \\ {A}_{p - 1} {x}_{p - 1}^{*}\end{matrix} ] \qquad ( 5 )$$

According to one aspect, the OSQP library may be used to solve the quadratic problem in Equation (5) starting from the most prior task and commanding the torque solutions to the motors obtained at the least prior task.

### Physical Constraints

It may be desired that the optimized solution satisfies the equations of motion and does not violate the physical limits of the robot portion. In this regard, the Equation of Motion or Equation (1) may be converted to an equality constraint as:

$${A}_{EOM} = [ M , - {𝕀}_{{n}_{j} \times {n}_{j}} ] \qquad ( 6 )$$

$${b}_{EOM} = [ - b - g - {J}^{T} {F}_{int} - {τ}_{friction} ]$$

Joint Limits: Joint torque and acceleration constraints may be formulated as:

$${D}_{{τ}_{max}^{+}} = [ {0}_{{n}_{j} \times {n}_{j}} , {𝕀}_{{n}_{j} \times {n}_{j}} ] , {f}_{{τ}_{max}^{+}} = {τ}_{max} \qquad ( 7 )$$

$${D}_{{τ}_{max}^{-}} = [ {0}_{{n}_{j} \times {n}_{j}} , - {𝕀}_{{n}_{j} \times {n}_{j}} ] , {f}_{{τ}_{max}^{-}} = {τ}_{max}$$

$${D}_{{\ddot{q}}^{+}} = [ {𝕀}_{{n}_{j} \times {n}_{j}} , {0}_{{n}_{j} \times {n}_{j}} ] , {f}_{{\ddot{q}}^{+}} = {\ddot{q}}_{max}$$

$${D}_{{\ddot{q}}^{-}} = [ - {𝕀}_{{n}_{j} \times {n}_{j}} , {0}_{{n}_{j} \times {n}_{j}} ] , {f}_{{\ddot{q}}^{+}} = {\ddot{q}}_{max}$$

where Tₘₐₓ, \ddot{q}ₘₐₓ ∈ [symbol] ⁿ may be the maximum allowable motor torques and accelerations, respectively.

Joint position and velocity constraints may be converted to joint acceleration constraints such that the velocity and positions do not exceed the defined limits in kΔt amount of time, where k may be a user defined constant and Δt may be the control period:

$${D}_{{\dot{q}}^{+}} = [ {𝕀}_{{n}_{j} \times {n}_{j}} , {0}_{{n}_{j} \times {n}_{j}} ] , {f}_{{\dot{q}}^{+}} = \frac{{\dot{q}}_{max} - \dot{q}}{k Δ t} \qquad ( 8 )$$

$${D}_{{\dot{q}}^{-}} = [ - {𝕀}_{{n}_{j} \times {n}_{j}} , {0}_{{n}_{j} \times {n}_{j}} ] , {f}_{{\dot{q}}^{-}} = \frac{{\dot{q}}_{max} + \dot{q}}{k Δ t}$$

$${D}_{{q}^{+}} = [ {𝕀}_{{n}_{j} \times {n}_{j}} , {0}_{{n}_{j} \times {n}_{j}} ] , {f}_{{q}^{+}} = \frac{2 ( {q}_{max} - q - \dot{q} k Δ t )}{{( k Δ t )}^{2}}$$

$${D}_{{q}^{-}} = [ - {𝕀}_{{n}_{j} \times {n}_{j}} , {0}_{{n}_{j} \times {n}_{j}} ] , {f}_{{q}^{-}} = \frac{- 2 ( {q}_{min} - q - \dot{q} k Δ t )}{{( k Δ t )}^{2}}$$

where \ddot{q}ₘₐₓ ∈ [symbol] ⁿ may be the maximum allowable motor speed and qₘₐₓ, qₘᵢₙ ∈ [symbol] ⁿ may be the joint limits.

### Desired Limits

For the human and environment, it may be usually desired to avoid the robot portion entering some regions in the task space. In this regard, having a virtual wall around the head of the partner or around sharp objects may be some examples of possible constraints in a robot mediated human-human interaction scenario as a space limitation. As a pre-collision measure, the velocity of the end-effector may be limited. When the contact may be desired, the robot portions need to avoid the force applied to the human partner causing harm or discomfort. Pain onsets for specific body areas may be used as interaction force thresholds.

### Virtual Task Space Limits

Similar to joint position and velocity limits, task space limits may be converted into acceleration constraints. End-effector acceleration may be expressed as:

$${⌈ \ddot{r} , \ddot{ϕ} ⌉}^{T} = J \ddot{q} + \dot{J} \dot{q} \qquad ( 9 )$$

This may lead to the following D matrices and f vectors for the formulation of six dimensional task space velocity (vₘₐₓ) and three dimensional linear position (Tₘₐₓ, rₘᵢₙ) constraints:

$${D}_{{v}^{+}} = [ J , {0}_{6 \times {n}_{j}} ] , {f}_{{v}^{+}} = \frac{{v}_{max} - J \dot{q}}{k Δ t} - \dot{J} \dot{q} \qquad ( 10 )$$

$${D}_{{v}^{-}} = [ - J , {0}_{6 \times {n}_{j}} ] , {f}_{{v}^{-}} = \frac{{v}_{max} + \dot{J} \dot{q}}{k Δ t} + \dot{J} \dot{q}$$

$${D}_{{r}^{+}} = [ {J}_{lin} , {0}_{3 \times {n}_{j}} ] , {f}_{{r}^{+}} = \frac{2 ( {r}_{max} - r - {J}_{lin} \dot{q} k Δ t )}{{( k Δ t )}^{2}} - {\dot{J}}_{l i n} \dot{q}$$

$${D}_{{r}^{-}} = [ - {J}_{lin} , {0}_{3 \times {n}_{j}} ] , {f}_{{r}^{-}} = \frac{- 2 ( {r}_{min} - r - {J}_{lin} \dot{q} k Δ t )}{{( k Δ t )}^{2}} - {\dot{J}}_{l i n} \dot{q}$$

where Jₗᵢₙ may be the linear component of the end-effector Jacobian expressed in the world frame.

### Interaction Force Limits

Even though the interaction force at the end-effector may be directly measured, it may be necessary to express it in terms of the optimization variables (i.e., joint accelerations and torques). Rearranging Equation (1) and omitting the inertial term, estimated interaction force may be:

$$\hat{F} = {( {J}^{T} )}^{†} ( {τ}_{motor} - b - g - {τ}_{fric} ) \qquad ( 11 )$$

where (J^{T})^{†} may be the damped pseudo inverse of the end-effector Jacobian transpose.

The damping may be activated if the manipulability measure, \sqrt{|JJ^{T}|}, may be below a threshold. Damping amount may be inversely proportional with the manipulability. Note that this estimation assumes accurate modeling and negligible accelerations. Using Equation (11), interaction force constraints may be implemented as:

$${D}_{{F}^{+ =}} [ {0}_{6 \times {n}_{j}} , {( {J}^{T} )}^{†} ] , {f}_{{F}^{+}} = {F}_{max} + {( {J}^{T} )}^{†} ( b + g ) \qquad ( 12 )$$

$${D}_{{F}^{-}} = [ {0}_{6 \times {n}_{j}} , - {( {J}^{T} )}^{†} ] , {f}_{{F}^{-}} = {F}_{max} - {( {J}^{T} )}^{†} ( b + g )$$

### Desired End-Effector Acceleration

The bilateral physical interaction between two humans may be created by mirroring the end-effector pose of the operator's robot portion on the partner's robot portion and rendering the measured interaction force of the partner's robot portion on the operator's robot portion.

It may be desired that the operator be aware of any active constraints on the partner's robot portion. This may be achieved together with force rendering. One of the benefits of the method may be that the operator's robot portion does not need to receive the joint states of the partner's robot portion or its kinematic/dynamic parameters.

### Partner's Robot Portion-Pose Tracking

Desired end-effector acceleration may be calculated based on the difference between the pose of the operator's and partner's end-effectors. Position and orientation error may be:

$${r}_{err} = {}_{{W}_{O}} {r}_{WO} - {}_{{W}_{P}} {r}_{WP} \qquad ( 13 )$$

$$[ {ϕ}_{err} ] = log ( {R}_{WP}^{T} {R}_{WO} )$$

where wᵢ^{T}wᵢ and R_{wi} represents the end-effector position and orientation of the operator (i=0) or partner (i=P) from and expressed in the corresponding world frame, respectively. [ϕₑᵣᵣ] may be the skew symmetric representation of the orientation error.

Desired linear and rotational end-effector accelerations may be:

$${\ddot{r}}_{P}^{des} = {K}_{lin} {r}_{err} + {D}_{lin} {\dot{r}}_{err} \qquad ( 14 )$$

$${\ddot{ϕ}}_{P}^{des} = {K}_{rot} {ϕ}_{err} + {D}_{rot} {\dot{ϕ}}_{err}$$

where K and D may be the user-defined impedance parameters for pose tracking.

### Operator's Robot Portion-Force Rendering

It may be desired for the operator to feel the forces exerted on the partner's robot portion so that the nature of the contact and physical cues from the partner may be perceived. Moreover, at the same time, the physical limitations of the partner's robot portion should be felt by the operator. This would allow the operator to modify his/her movements to be compatible with the partner's robot portion capabilities. In this regard, the processor 152 may implement the constraint associated with the first robot portion 100 as feedback on the second robot portion 200.

A closed-loop admittance controller at the end-effector's acceleration level may be implemented to render the six-dimensional force and torques.

$${[ {\ddot{r}}_{O}^{adm} , {\ddot{ϕ}}_{O}^{adm} ]}^{T} = \frac{{F}_{P} - {F}_{O}}{{Λ}_{virt}} \qquad ( 15 )$$

where [\ddot{r}ₒ^{adin}, \ddot{ϕ}ₒ^{adin}]^{T}∈ [symbol] ⁶ may be the desired linear and angular end-effector acceleration from the admittance controller. Fᵢ ∈ [symbol] ⁶ may be the wrench measured at partner's (i=P) and operator's (i=0) end-effector. ∧ᵥᵢᵣₜ ␣ [symbol] ^{6x6} may be the user defined virtual task space mass matrix. The virtual task space matrix may be set such that it may be a scaled down version of the actual task space mass matrix:

$$Λ = {( {JM}^{- 1} {J}^{T} )}^{- 1} \qquad ( 16 )$$

$${Λ}_{virt} = α Λ$$

where a may be a scalar. Smaller a leads to better force rendering; however, there may be a lower limit on a for stable response due to the modeling errors and actuator capabilities. The fact that it may be merely a one-dimensional term may make it beneficially easier to tune this parameter.

If the partner's robot portion cannot track the desired end-effector acceleration due to constraints, this may result in a difference between the desired and optimized accelerations. The optimized end-effector acceleration, ï* may be calculated using Equation (9) and optimized joint accelerations. The difference between the end-effector optimized and desired accelerations due to the constraints is:

$$[ \begin{matrix}{\ddot{r}}_{P}^{const} \\ {\ddot{ϕ}}_{P}^{const}\end{matrix} ] = [ \begin{matrix}{\ddot{r}}_{P}^{*} \\ {\ddot{ϕ}}_{P}^{*}\end{matrix} ] - [ \begin{matrix}{\ddot{r}}_{P}^{des} \\ {\ddot{ϕ}}_{P}^{des}\end{matrix} ] \qquad ( 17 )$$

The acceleration commands from the admittance controller and the acceleration error on the partner side due to constraints may be summed to form the desired end-effector acceleration of the operator:

$$[ \begin{matrix}{\ddot{r}}_{O}^{des} \\ {\ddot{ϕ}}_{O}^{* des}\end{matrix} ] = [ \begin{matrix}{\ddot{r}}_{O}^{adm} \\ {\ddot{ϕ}}_{O}^{adm}\end{matrix} ] + w [ \begin{matrix}{\ddot{r}}_{P}^{const} \\ {\ddot{ϕ}}_{P}^{const}\end{matrix} ] \qquad ( 18 )$$

where w may be the adjustable weight for feeding the partner's constraints.

Desired end-effector accelerations may be formulated as equality constraints as follows:

$${A}_{\ddot{q}} = [ J , {0}_{6 \times {n}_{j}} ] , {b}_{\ddot{q}} = {[ {\ddot{r}}^{des} , {\ddot{ϕ}}^{des} ]}^{T} - J \dot{q} \qquad ( 19 )$$

### Joint Acceleration Minimization

As desired end-effector acceleration tasks in Equations (14) and (18) may be six-dimensional and the robot portions have seven DoF, there may be infinitely many solutions when no higher priority constraints (e.g., position limit) may be active. This may result in the optimizer converging on discontinuous joint acceleration and torques. To avoid this, minimum joint accelerations that generate the desired end-effector acceleration may be chosen. Minimization of joint accelerations may be formulated as an equality constraint with zero reference as:

$${A}_{{\ddot{q}}^{O}} = [ {𝕀}_{{n}_{j} \times {n}_{j}} , {0}_{{n}_{j} \times {n}_{j}} ] , {b}_{{\ddot{q}}^{O}} = {0}_{{n}_{j}} \qquad ( 20 )$$

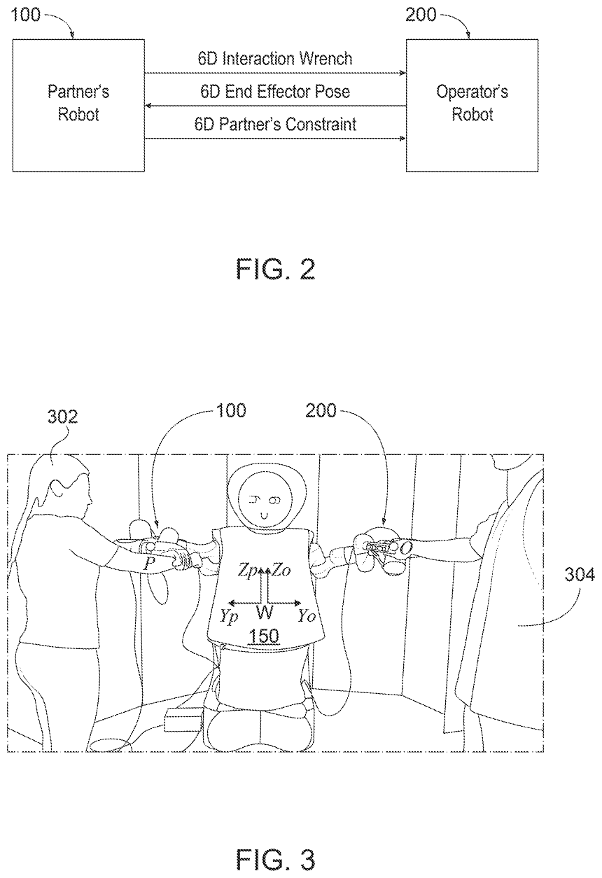

FIG. 2 is an exemplary component diagram of a system for robot-mediated physical human-human interaction, according to one aspect. According to one aspect, the control portion 150 may be implemented across the first robot portion 100 and the second robot portion 200, as seen in FIG. 2. Here, the first robot portion 100 and/or the second robot portion 200 may perform any of the calculations, analysis, and/or computations described with reference to the processor of the control portion 150 of the system for robot-mediated physical human-human interaction. In this way, an interaction wrench felt at the partner's robot portion end-effector may be sent to the operator's robot portion as a reference value. Similarly, pose of the operator's robot's end-effector may be sent to the partner's robot portion. The partner's robot portion may send the resulting effects of any constraints on the end-effector motion. In this way, the first robot portion 100 may act as the partner and the second robot portion 200 may act as the operator.

According to one aspect where the roles are reversed, the processor of the partner robot portion may perform receiving an interaction wrench signal indicative of a wrench force associated with the first robot portion 100, generating and transmitting an end-effector pose signal indicative of a pose associated with the second robot portion 200, receiving a constraint signal indicative of a constraint associated with the first robot portion 100 based on the end-effector pose signal associated with the second robot portion 200, and implementing the constraint associated with the first robot portion 100 as feedback on the second robot portion 200.

According to one aspect, the processor of the operator robot portion may perform generating and transmitting an interaction wrench signal indicative of a wrench force associated with the first robot portion 100, receiving an end-effector pose signal indicative of a pose associated with the second robot portion 200, generating and transmitting a constraint signal indicative of a constraint associated with the first robot portion 100 based on the end-effector pose signal associated with the second robot portion 200, and implementing the constraint associated with the first robot portion 100.

FIG. 3 is an exemplary illustration of a system for robot-mediated physical human-human interaction, according to one aspect. According to another aspect, the first robot portion 100, the second robot portion 200, and the control portion 150 may be local, as illustrated in FIG. 3. A first user 302 may interact with the first robot portion 100 as a partner and a second user 304 may interact with the second robot portion 200 as an operator.

As discussed above, it may be possible to reverse the roles of the operator and the partner, as the system may operate in a bilateral fashion. In this regard, the processor 152 may receive an interaction wrench signal indicative of a wrench force associated with the second robot portion 200. The processor 152 may receive an end-effector pose signal indicative of a pose associated with the first robot portion 100. The processor 152 may generate a constraint signal indicative of a constraint associated with the second robot portion 200 based on the end-effector pose signal associated with the first robot portion 100. The processor 152 may implement the constraint associated with the second robot portion 200 as feedback on the first robot portion 100.

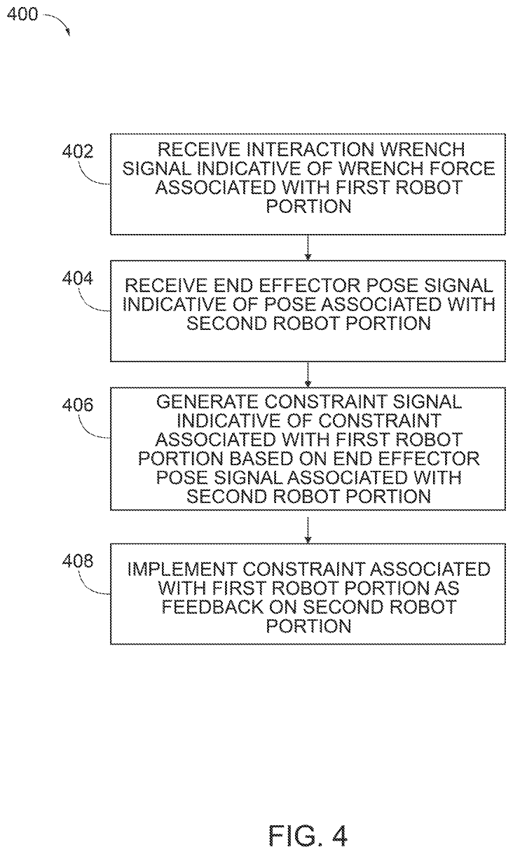

FIG. 4 is an exemplary flow diagram of a computer-implemented method 400 for robot-mediated physical human-human interaction, according to one aspect. The computer-implemented method 400 for robot-mediated physical human-human interaction may include receiving 402 an interaction wrench signal indicative of a wrench force associated with the first robot portion 100, receiving 404 an end-effector pose signal indicative of a pose associated with the second robot portion 200, generating 406 a constraint signal indicative of a constraint associated with the first robot portion 100 based on the end-effector pose signal associated with the second robot portion 200, and implementing 408 the constraint associated with the first robot portion 100 as feedback on the second robot portion 200. Again, it will be appreciated that the computer-implemented method 400 may be specific to one implementation or embodiment and that any of the receiving, transmitting, or generating described above may be interchangeably or modularly shifted to another processor of another portion of the system.

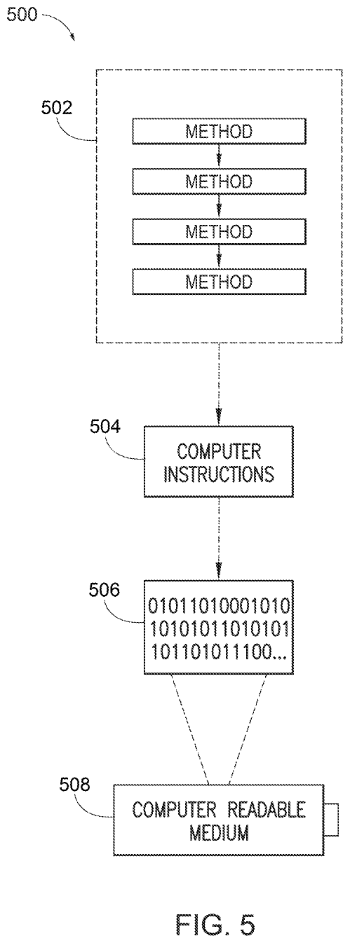

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein. In this implementation 500, the processor-executable computer instructions 504 may be configured to perform a method 502, such as the computer-implemented method 400 of FIG. 4. In another aspect, the processor-executable computer instructions 504 may be configured to implement a system, such as the system for robot-mediated physical human-human interaction of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

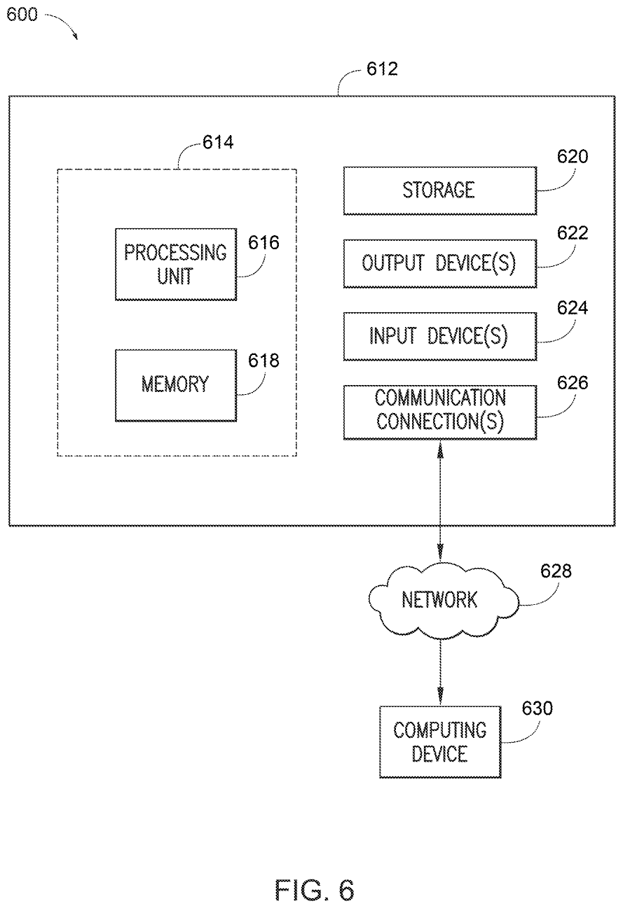

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one aspect provided herein. In one configuration, the computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other aspects, the computing device 612 includes additional features or functionality. For example, the computing device 612 may include additional storage such as removable storage or non-removable storage, including, but not limited to, magnetic storage, optical storage, etc. Such additional storage is illustrated in FIG. 6 by storage 620. In one aspect, computer readable instructions to implement one aspect provided herein are in storage 620. Storage 620 may store other computer readable instructions to implement an operating system, an application program, etc. Computer readable instructions may be loaded in memory 618 for execution by the at least one processing unit 616, for example.

The term “computer readable media” as used herein includes computer storage media. Computer storage media includes volatile and nonvolatile, removable, and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 612. Any such computer storage media is part of the computing device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 612 includes input device(s) 624 such as keyboard, mouse, pen, voice input device, touch input device, infrared cameras, video input devices, or any other input device. Output device(s) 622 such as one or more displays, speakers, printers, or any other output device may be included with the computing device 612. Input device(s) 624 and output device(s) 622 may be connected to the computing device 612 via a wired connection, wireless connection, or any combination thereof. In one aspect, an input device or an output device from another computing device may be used as input device(s) 624 or output device(s) 622 for the computing device 612. The computing device 612 may include communication connection(s) 626 to facilitate communications with one or more other devices 630, such as through network 628, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for robot-mediated physical human-human interaction, comprising:
a memory storing one or more instructions;
a processor executing one or more of the instructions stored on the memory to perform;
receiving an interaction wrench signal indicative of a wrench force associated with a first robot portion;
receiving an end-effector pose signal indicative of a pose associated with a second robot portion;
generating a constraint signal indicative of a constraint associated with the first robot portion based on the end-effector pose signal associated with the second robot portion; and
implementing the constraint associated with the first robot portion as feedback on the second robot portion.

2. The system for robot-mediated physical human-human interaction of claim 1, wherein the wrench force of the interaction wrench signal is indicative of an interaction between a first human and the first robot portion.

3. The system for robot-mediated physical human-human interaction of claim 1, wherein the end-effector pose signal is provided by a second human interacting with the second robot portion.

4. The system for robot-mediated physical human-human interaction of claim 1, wherein the end-effector pose signal is indicative of a desired pose for the first robot portion.

5. The system for robot-mediated physical human-human interaction of claim 1, wherein the constraint signal is indicative of a joint torque limitation, a joint velocity limitation, a joint acceleration limitation, or a joint position limitation for the second robot portion.

6. The system for robot-mediated physical human-human interaction of claim 1, wherein the constraint signal is indicative of a space limitation for the second robot portion.

7. The system for robot-mediated physical human-human interaction of claim 1, wherein the constraint signal is indicative of an interaction force limitation for the second robot portion.

8. The system for robot-mediated physical human-human interaction of claim 1, wherein:
the processor receives an interaction wrench signal indicative of a wrench force associated with the second robot portion; and
the processor receives an end-effector pose signal indicative of a pose associated with the first robot portion.

9. The system for robot-mediated physical human-human interaction of claim 8, wherein:
the processor generates a constraint signal indicative of a constraint associated with the second robot portion based on the end-effector pose signal associated with the first robot portion; and
the processor implements the constraint associated with the second robot portion as feedback on the first robot portion.

10. The system for robot-mediated physical human-human interaction of claim 1, wherein:
the processor generates the constraint signal to be indicative of a second constraint associated with the first robot portion based on the end-effector pose signal associated with the second robot portion;
the processor prioritizes the constraint and the second constraint based on whether the first robot portion is acting as an operator or a partner; and
implementing the constraint and the second constraint.

11. A computer-implemented method for robot-mediated physical human-human interaction, comprising:
receiving an interaction wrench signal indicative of a wrench force associated with a first robot portion;
receiving an end-effector pose signal indicative of a pose associated with a second robot portion;
generating a constraint signal indicative of a constraint associated with the first robot portion based on the end-effector pose signal associated with the second robot portion; and
implementing the constraint associated with the first robot portion as feedback on the second robot portion.

12. The computer-implemented method for robot-mediated physical human-human interaction of claim 11, wherein the wrench force of the interaction wrench signal is indicative of an interaction between a first human and the first robot portion.

13. The computer-implemented method for robot-mediated physical human-human interaction of claim 11, wherein the end-effector pose signal is provided by a second human interacting with the second robot portion.

14. The computer-implemented method for robot-mediated physical human-human interaction of claim 11, wherein the end-effector pose signal is indicative of a desired pose for the first robot portion.

15. The computer-implemented method for robot-mediated physical human-human interaction of claim 11, wherein the constraint signal is indicative of a joint torque limitation, a joint velocity limitation, a joint acceleration limitation, or a joint position limitation for the second robot portion.

16. The computer-implemented method for robot-mediated physical human-human interaction of claim 11, wherein the constraint signal is indicative of a space limitation for the second robot portion.

17. The computer-implemented method for robot-mediated physical human-human interaction of claim 11, wherein the constraint signal is indicative of an interaction force limitation for the second robot portion.

18. The computer-implemented method for robot-mediated physical human-human interaction of claim 11, comprising:
receiving an interaction wrench signal indicative of a wrench force associated with the second robot portion; and
receiving an end-effector pose signal indicative of a pose associated with the first robot portion.

19. The computer-implemented method for robot-mediated physical human-human interaction of claim 18, comprising:
generating a constraint signal indicative of a constraint associated with the second robot portion based on the end-effector pose signal associated with the first robot portion; and
implementing the constraint associated with the second robot portion as feedback on the first robot portion.

20. A system for robot-mediated physical human-human interaction, comprising:
a memory storing one or more instructions;
a processor executing one or more of the instructions stored on the memory to perform;
receiving an interaction wrench signal indicative of a wrench force associated with a first robot portion;
generating and transmitting an end-effector pose signal indicative of a pose associated with a second robot portion;
receiving a constraint signal indicative of a constraint associated with the first robot portion based on the end-effector pose signal associated with the second robot portion; and
implementing the constraint associated with the first robot portion as feedback on the second robot portion.
